(19) United States
(12) Patent Application Publication
(10) Pub. No.: US 2026/0198612 A1
(43) Pub. Date: Jul. 16, 2026

(54) DEVICE AND METHOD FOR VAPORIZING A LIQUID FOR AN ELECTRIC CIGARETTE

(71) Applicant: Fraunhofer-Gesellschaft zur Förderung der angewandten Forschung e.V., München (DE)

(72) Inventors: Jörg Oppermann, Otze/Burgdorf (DE); Horst Windt, Burgwedel (DE); Thore Wagner, Wilhemshaven (DE); Katharina Blümlein, Hannover (DE); Stefanie Scheffler, Hannover (DE)

(73) Assignee: Fraunhofer-Gesellschaft zur Förderung der angewandten Forschung e.V., München (DE)

(21) Appl. No.: 19/129,901

(22) PCT Filed: Nov. 13, 2023
(86) PCT No.: PCT/EP2023/081611

§ 371 Date: May 14, 2025

(30) Foreign Application Priority Data
Nov. 14, 2022 (DE) 102022212052.3

(51) Int. Cl. A24F 40/80; A24F 40/10; A24F 40/51; G01J 5/00; G05D 23/19; H05B 1/02; H05B 3/00

(52) U.S. Cl. CPC A24F 40/80; A24F 40/10; A24F 40/51; G01J 5/0037; G05D 23/1917; H05B 1/0244; H05B 3/0004; H05B 2203/021

(57) ABSTRACT

A device (100) for vaporizing a liquid for an electric cigarette is proposed. The device (100) comprises a sample holder (102) for holding a sample carrier (104), the sample carrier (104) being at least partially made of an electrically conductive material, the sample carrier (104) being configured to hold a predetermined amount of liquid for an electric cigarette. The device (100) further comprises two electrodes (108), wherein the electrodes (108) are configured to heat the sample carrier (104) to at least one predetermined temperature by applying an electrical voltage to the sample carrier (104). The device (100) further comprises a temperature sensor (110), wherein the temperature sensor (110) is configured to detect a temperature of the sample carrier (104). The device (100) further comprises a housing (114), the housing (114) surrounding the sample holder (102) and the electrodes (108), the housing (114) having a port (118), the port (118) being configured to remove emissions during heating of the predetermined amount of liquid. Further proposed is a method for vaporizing a liquid for an electric cigarette.

### TECHNICAL AREA

The present invention relates to a device for vaporizing a liquid for an electric cigarette. The present invention further relates to a method for vaporizing a liquid for an electric cigarette.

### TECHNICAL BACKGROUND

The electric cigarette, e-cigarette, electronic cigarette or vaporiser/vaporizer (AE; therefore also called vape or e-vape for short), is a device that in most cases vaporizes a liquid (the so-called e-liquid) through an electrically heated coil. The resulting wet vapor is inhaled or puffed by the consumer. Unlike smoking a conventional cigarette, no combustion process takes place.

There are a variety of different devices on the market, which differ in vaporizer principle, liquid capacity, battery capacity and possible regulation of the supply voltage. Disposable systems are used rather rarely by permanent users of e-cigarettes. These include, for example, the “cig-a-likes” that visually resemble a filter cigarette and some of the so-called e-shishas. E-shishas have a colorful appearance, contain sweet flavorings and usually no nicotine. Typically, permanent e-cigarette users use systems with rechargeable batteries and refillable vaporizers, where the vaporizer and the device supplying it with electrical voltage—referred to as a (rechargeable) battery or battery carrier, depending on the type—are usually conductively connected via a screw thread. This usually allows both parts of the device to be purchased, combined and exchanged individually according to the buyer's requirements and tastes. Individual manufacturers deviate from this and use proprietary connection mechanisms between the vaporizer and the battery.

Most vaporizers contain a vaporizer head with one or more heating coils, which are supplied with energy from the battery. The liquid to be vaporized, the e-liquid, enters the vaporizer head through capillary action of the liquid carrier, is heated and atomized in the air flow. Absorbent cotton tufts, wicks made of fiberglass or metal, or screen plates made of metal or ceramic are used as liquid carriers. There is an airflow channel in the vaporizer. In the majority of devices, the volume flow is adjustable. As soon as the user pulls the mouthpiece and presses the button to heat the heating coil (in some devices also fully automatically), the produced “vapor” (actually, it is an aerosol) is transported together with the air flow and can be inhaled or puffed.

The liquid carrier and heating wire have a very limited service life compared to the other components. Therefore, it meets the requirements of operation to be able to easily change these consumable parts. Vaporizer types can be differentiated according to how this consumable can be changed.

The liquid to be vaporized is called e-liquid and consists of propylene glycol (food additive E 1520) and glycerin (food additive E 422). The additives are abbreviated PG for propylene glycol and VG for vegetable glycerin. Pure water (H2O), small parts of food flavoring and nicotine are optional. Apart from nicotine, these ingredients are also found in the fog fluids for fog machines that have been in use for decades, but which is inhaled in much lower concentrations when it is commonly used. The vapor of the liquid creates a sensory experience that is supposed to correspond to the sensation of inhaling cigarette smoke, transporting nicotine and other substances contained in the liquid, which are absorbed directly by the consumer.

The carrier substances glycerol and propylene glycol serve primarily to produce a fog that is perceived as pleasant by the consumer. The hygroscopic effect of these substances causes an additional enrichment of water from the ambient air, which increases the vapor density. Glycerin has a stronger effect than propylene glycol, provided that the device used has sufficient power. The ratio of the two carriers is also used to adjust the viscosity of the liquid. This must be sufficiently low to prevent the vaporizer from running dry (see Dry-Hit section). At the same time, leakage problems of older design devices led to liquids with too low viscosity all too often emptying into the owners' pockets. The generally more powerful modern devices are better able to preheat the liquid in the tank, so that the devices can also vaporize glycerin-rich liquids without running dry. Since leakage problems have also been largely eliminated, there are currently hardly any technical limits to the composition of the liquid.

Propylene glycol is more suitable as a carrier for flavors and nicotine, but causes a slight dehydration of the oral mucosa, which is perceived as unpleasant by some consumers. Accordingly, there is a general trend toward liquids that are richer in glycerin, with the lack of carrier properties being compensated for by higher device performance. Another fine-tuning option is the addition of water to reduce the dehydration effect and to increase vapor density and adjust viscosity.

Since 2014, e-cigarettes and e-cigarette liquids have been regulated by the TPD (Tobacco Product Directive 2014/40/EU). The German implementation of the TPD is the Tobacco Products Ordinance (TabakerzV) and the Tobacco Products Act (TabakerzG). According to the TabakerzG, in addition to nicotine, only ingredients that do not pose a risk to human health in either heated or unheated form may be used in e-liquids. Manufacturers must notify their products, reporting all ingredients in the liquid as well as toxicological data in heated and unheated form and their effects on consumer health. However, no parameters are defined for generating this data (e.g., maximum temperature). Manufacturers usually test their e-liquids using commercially available e-cigarettes. For the determination of the inhaled substances, coupling of gas chromatography and HPLC with mass spectrometry are mainly used after appropriate sample preparation. These analytical methods can also be used to determine carcinogenic substances in the urine of e-cigarette users and regular smokers.

However, considering that electric cigarettes exist in many different designs and operate in different wattage ranges, the conditions under which e-liquids are heated are not uniform. In an electric cigarette, the liquid is heated by a heating wire. This wire is located inside the e-cigarette and determining the temperature is technically difficult. On the one hand, the temperature of the wire depends on the applied voltage, and on the other hand, the temperature is influenced by various external factors. These are, among other things, contact with the e-liquid, the air flow created when pulling on the e-cigarette and possible inhomogeneities in the wire.

Even when using a single model with unchanged operating parameters, the temperature to which the liquid is exposed is not constant or precisely known, either spatially or temporally. This is particularly relevant when e-liquids contain components that decompose at a certain temperature to form toxic decomposition products.
US 2017/020195 A1 discloses an electronic vaporizer testing.
U.S. Pat. No. 10,667,560 B2 discloses a vaporizer apparatus.
EP 2 407 235 A1 discloses a liquid sample heating vaporizer.

### OBJECT OF THE INVENTION

It would therefore be desirable to provide a device and a method for vaporizing a liquid for an electric cigarette in preparation for subsequent analysis, which at least largely avoid the disadvantages of known devices and methods. In particular, a device and a method for vaporizing a liquid for an electric cigarette should be made available, with which e-liquids can be heated under defined and reproducible conditions and the resulting emissions can be analyzed qualitatively and quantitatively for selected substances after suitable collection/sampling.

### GENERAL DESCRIPTION OF THE INVENTION

This object is addressed by a device and a method with the features of the independent patent claims. Advantageous further developments, which can be realized individually or in any combination, are shown in the dependent claims.

As used in the following, the terms “have”, “comprise” or “include” or any arbitrary grammatical variations thereof are used in a non-exclusive way. Thus, these terms may both refer to a situation in which, besides the feature introduced by these terms, no further features are present in the entity described in this context and to a situation in which one or more further features are present. As an example, the expressions “A has B”, “A comprises B” and “A includes B” may both refer to a situation in which, besides B, no other element is present in A (i.e. a situation in which A solely and exclusively consists of B) and to a situation in which, besides B, one or more further elements are present in entity A, such as element C, elements C and D or even further elements.

Further, it shall be noted that the terms “at least one”, “one or more” or similar expressions indicating that a feature or element may be present once or more than once typically will be used only once when introducing the respective feature or element. In the following, in most cases, when referring to the respective feature or element, the expressions “at least one” or “one or more” will not be repeated, non-withstanding the fact that the respective feature or element may be present once or more than once.

Further, as used in the following, the terms “preferably”, “more preferably”, “particularly”, “more particularly”, “specifically”, “more specifically” or similar terms are used in conjunction with optional features, without restricting alternative possibilities. Thus, features introduced by these terms are optional features and are not intended to restrict the scope of the claims in any way. The invention may, as the skilled person will recognize, be performed by using alternative features. Similarly, features introduced by “in an embodiment of the invention” or similar expressions are intended to be optional features, without any restriction regarding alternative embodiments of the invention, without any restrictions regarding the scope of the invention and without any restriction regarding the possibility of combining the features introduced in such way with other optional or non-optional features of the invention.

According to a first aspect of the present invention, a device for vaporizing a liquid for an electric cigarette is proposed. The device includes a sample holder for holding a sample carrier. The sample carrier is at least partially made of an electrically conductive material. The sample carrier is configured to hold a predetermined amount of liquid for an electric cigarette. This allows a standardized amount of liquid to be applied to the sample carrier. Since the sample carrier need not be firmly connected to the sample holder, the sample carrier is preferably interchangeable and accordingly is not a fixed component of the device. Preferably, the sample carrier is made of a comparatively inexpensive material so as not to significantly increase operating costs by replacement.

The device further comprises two electrodes. The electrodes are configured to heat the sample carrier to at least one predetermined temperature by means of applying an electrical voltage to the sample carrier. In other words, the sample carrier, and thus the fluid received thereon or therein, heats when an electrical voltage is applied to the electrodes as a result of current flow through the sample carrier. The temperature and speed of heating of the sample carrier and thus of the liquid can be adjusted accordingly by the magnitude of the applied electrical voltage. In this way, standardized heating can be realized.

The device further comprises a temperature sensor. The temperature sensor is configured to detect a temperature of the sample carrier. This makes it possible to monitor the heating of the sample carrier or the liquid and thus the evaporation of the liquid.

The device further comprises a housing. The housing surrounds the sample holder and electrodes. The housing includes a port or connector. The port or connector is configured to remove emissions during heating of the predetermined amount of liquid. The housing thus prevents emissions, such as aerosols, generated during vaporization of the liquid from escaping uncontrolled into the environment from the device. The port allows the emissions to be removed from inside the housing.

The port or connector can be configured to connect to an analyzer port or connector of an analyzer. This allows the emissions to be fed to an analyzer and analyzed.

The housing can be a glass bell. The connection can be a sleeve of a ground joint. A glass bell is substantially inert to the emissions generated and allows visual inspection of the evaporation process. By providing a sleeve of a ground joint, an analyzer with a standardized or normed connection can be connected to the device.

The sleeve can be designed, for example, to connect to a core of a ground joint of a glass connection. In this way, a tight connection to the analyzer can be realized in a particularly simple manner.

The electrodes can be integrated into the sample holder. Alternatively, the electrodes can be attached to the sample carrier. Integrating the electrodes into the sample holder has the advantage that a space-saving arrangement of the electrodes and the sample holder is realized. Thus, the electrodes and the sample holder can be designed as one unit. For example, the electrodes are also designed as sample holders. A separate design of the electrodes and the sample holder allows this to be removed or replaced more easily for maintenance or repair purposes.

The device may further comprise a voltage source for applying the electrical voltage to the electrodes. The voltage source may be designed to vary the applied electrical voltage. This can be used to adjust the amount of current flowing through the sample carrier and thus the heating of the sample carrier.

The electrodes can be designed to heat the sample carrier with a predetermined temperature profile. Accordingly, a standardized heating of the liquid can be realized, in which both the level of the temperature, the speed of the heating and the duration of the heating are predetermined.

The sample carrier can be at least partially and preferably completely porous. As a result, the heating of the liquid not only takes place on the outer surface of the sample carrier, but the effective heat transfer surface is significantly increased, since the liquid also penetrates into the pores inside the sample carrier.

The sample carrier can be made at least partially, and preferably completely, of metal. This means that the sample carrier is made of an electrically conductive material, which allows current to flow through the sample carrier and thus allows the sample carrier to be heated.

The sample carrier can be a fleece. This makes the sample carrier inexpensive to manufacture and at the same time porous, so that it can absorb the liquid well.

The sample holder can be designed to orient the sample carrier substantially vertically or substantially horizontally. In this way, the evaporation of the liquid can be specifically influenced. A vertical orientation, for example, creates turbulence between the surrounding air and the evaporating liquid, so that the evaporation performance is increased.

The temperature sensor can touch the sample carrier. This allows the temperature to be detected exactly at the point of vaporization of the liquid.

Alternatively, the temperature sensor can be designed for contactless detection of the temperature of the sample carrier. This prevents the evaporation from being negatively influenced or disturbed by the presence of a temperature sensor.

For example, the temperature sensor can be arranged outside the housing. This also prevents a negative influence of the evaporating liquid on the temperature sensor.

The temperature sensor can be an infrared temperature sensor. This enables particularly simple non-contact and interference-free temperature detection.

The device may further comprise a resistance measuring device. The resistance measuring device may be configured to measure an electrical resistance of the sample carrier. Since the electrical resistance of an electrical conductor depends on temperature, a measurement of the electrical resistance of the conductor can be used to infer the temperature of the conductor and the immediate environment. Accordingly, a measurement of the electrical resistance of the sample carrier can be used to draw conclusions about its temperature.

The device may further comprise a base. The housing may be removably disposed on the base. Thus, the base may be accessed by removing the housing.

The sample holder and the electrodes can be arranged on the base. Thus, by removing the housing, the sample carrier can be attached to and removed from the sample holder.

The housing may have a closable or sealable opening. The opening may be sized to allow passage of a sample application device for applying the predetermined amount of liquid to the sample carrier. Thus, the liquid can be applied even when the sample carrier is in a heated state without having to remove the housing. This can prevent emissions from escaping when the liquid is applied to the heated sample carrier.

According to another aspect of the present invention, a method of vaporizing a liquid for an electric cigarette is proposed. The method comprises the following steps, preferably in the order indicated. The method may comprise, in addition to the mentioned method steps, further method steps. Likewise, the steps may be repeated. Furthermore, the steps may be carried out at least partially in parallel or simultaneously. The method comprises:
Applying a predetermined amount of liquid for an electric cigarette to a sample carrier, wherein the sample carrier is at least partially made of an electrically conductive material,
Attaching the sample carrier to a sample holder,
Arranging a housing such that the housing surrounds the sample holder and two electrodes, the housing having a port,
Heating the sample carrier to at least a predetermined temperature by applying an electrical voltage to the sample carrier by means of the two electrodes,
Detecting a temperature of the sample carrier,
Evaporating the predetermined amount of liquid at the predetermined temperature, and
Removing of emissions during a heating of the predetermined amount of liquid.

Accordingly, a standardized amount of liquid can be applied to the sample carrier. Since the sample carrier does not have to be firmly connected to the sample holder, it is preferably replaceable and accordingly not a fixed component of the device. Preferably, the sample carrier is made of a comparatively inexpensive material so as not to significantly increase operating costs by replacement. Applying the electrical voltage to the sample carrier creates a current flow through it. The current flow in turn generates heat in the sample carrier. In other words, when an electrical voltage is applied to the electrodes, the sample carrier, and thus the liquid on it or in it, heats up as a result of the current flow through the sample carrier. The temperature and speed of heating of the sample carrier and thus of the liquid can be adjusted accordingly by the magnitude of the applied electrical voltage. Thus, a standardized heating can be realized. By detecting the temperature of the sample carrier, the heating of the sample carrier or liquid and thus the evaporation of the liquid can be monitored. The housing prevents the emissions, such as aerosols, produced during the evaporation of the liquid from escaping uncontrolled into the environment of the device. The port allows the emissions to be removed from inside the housing. This allows the emissions to be fed to an analyzer and analyzed.

The predetermined amount of liquid can be applied before heating the sample carrier. Thus, the liquid is heated together with the sample carrier and any emissions that occur with the start of heating can be fed to an analysis.

Alternatively, the predetermined amount of liquid can be applied in a heated state of the sample carrier. In this way, substances can also be analyzed that may only be formed when the sample is heated abruptly.

The method may further comprise connecting the port to an analyzer port of an analyzer. This allows the emissions to be supplied to an analyzer and analyzed.

The method may further comprise varying the electrical voltage applied to the electrodes depending on the type of electric cigarette whose liquid is to be vaporized. This adapts the type of vaporization to the particular type of electric cigarette to mimic its vaporization under standardized conditions.

The method may further comprise heating the sample carrier with a predetermined temperature profile. Accordingly, a standardized heating of the liquid can be realized, in which both the level of the temperature, the speed of the heating and the duration of the heating are predetermined.

The sample carrier can be at least partially and preferably completely porous. The predetermined amount of liquid can be applied to the sample carrier in such a way that the liquid penetrates at least partially into the pores. As a result, the heating of the liquid not only takes place on the outer surface of the sample carrier, but the effective heat transfer surface is significantly increased, since the liquid also penetrates into the pores inside the sample carrier.

The sample carrier can be made at least partially, and preferably completely, of metal. This means that the sample carrier is made of an electrically conductive material, which allows current to flow through the sample carrier and thus allows the sample carrier to be heated.

The sample carrier can be a fleece. This makes the sample carrier inexpensive to manufacture and at the same time porous, so that it can absorb the liquid well.

The method may further comprise orienting the sample carrier substantially vertically or substantially horizontally. This may selectively influence the evaporation of the liquid. For example, a vertical orientation creates turbulence between the surrounding air and the evaporating liquid so that the evaporation efficiency is increased.

The temperature can be detected by contact. This allows the temperature to be detected exactly at the point of evaporation of the liquid.

Alternatively, the temperature can be detected without contact. This prevents the evaporation from being negatively influenced or disturbed by the presence of a temperature sensor.

For example, a temperature sensor can be arranged outside the housing. This also prevents a negative influence of the evaporating liquid on the temperature sensor.

The method may further comprise measuring an electrical resistance of the sample carrier. Since the electrical resistance of an electrical conductor depends on temperature, a measurement of the electrical resistance of the conductor can be used to infer the temperature of the conductor and its immediate surroundings. Accordingly, a measurement of the electrical resistance of the sample carrier can be used to infer the temperature of the sample carrier.

The method may further comprise providing a base. The housing may be removably disposed on the base. Thus, the base may be accessed by removing the housing.

The sample holder and the electrodes can be arranged on the base. Thus, by removing the housing, the sample carrier can be attached to and removed from the sample holder.

The process may further comprise extraction of the emissions. This allows the emissions to be subjected to analysis.

The method may further comprise analyzing the emissions using at least one analytical method by at least one analytical instrument. This may be used to determine the ingredients of the liquid and to collect toxicological data in heated and non-heated form and their effects on consumer health.

The method may be carried out using a device according to one of the embodiments described above or below. This allows the method to be carried out safely.

The process can be computer-implemented. This can reduce the amount of work and personnel required.

The term “electronic cigarette” as used herein is a broad term to which shall be given its ordinary and common meaning as understood by those skilled in the art. The term is not limited to any specific or adapted meaning. The term may, without limitation, refer specifically to a device that causes a liquid (called e-liquid) to vaporize by heating. In most cases, the heating of the liquid is accomplished by an electrically heated filament (called a coil). The resulting wet vapor is inhaled or puffed by the consumer. Unlike smoking a conventional cigarette, no combustion process takes place.

The term “liquid for an electronic cigarette” as used herein is a broad term and is to be given its ordinary and customary meaning to a person of ordinary skill in the art and is not to be limited to a special or customized meaning. The term specifically may refer, without limitation, to a liquid suitable and adapted for use by an electronic cigarette. In other words, the liquid is intended for use with an electric cigarette. The liquid to be vaporized is also called e-liquid and consists of propylene glycol (food additive E 1520) and glycerin (food additive E 422). The additives are abbreviated PG for propylene glycol and VG for vegetable glycerin. Pure water (H₂O), small parts of food flavoring and nicotine are optional. Apart from nicotine, these ingredients are also found in the fog fluids for fog machines that have been in use for decades, but which is inhaled in much lower concentrations when it is commonly used. The vapor of the liquid creates a sensory experience that is supposed to correspond to the sensation of inhaling cigarette smoke, transporting nicotine and other substances contained in the liquid, which are absorbed directly by the consumer.

The term “sample holder” as used herein is a broad term and is to be given its ordinary and customary meaning to a person of ordinary skill in the art and is not to be limited to a special or customized meaning. The term specifically may refer, without limitation, toa component designed and arranged to hold or fix a sample carrier. In particular, the holding or fixing may be reversible or releasable. For example, the sample holder may have clamps, screw clamps, hooks or the like.

The term “sample carrier” as used herein is a broad term and is to be given its ordinary and customary meaning to a person of ordinary skill in the art and is not to be limited to a special or customized meaning. The term specifically may refer, without limitation, toa component configured and adapted to support and/or contain a sample of a predetermined amount of fluid. In particular, the sample carrier may be adapted to allow the liquid not only to remain superficially on the sample carrier, but to penetrate into the interior of the sample carrier. Thus, the sample carrier can in particular be designed to be porous and the liquid can penetrate into the pores. In particular, the sample carrier is at least partially made of an electrically conductive material. As a result, heating of the sample carrier and consequently of the liquid thereon and/or therein occurs when a current flows through the sample carrier. For example, the sample carrier can be a fleece made of an electrically conductive material, such as metal.

The term “electrode” as used herein is a broad term and is to be given its ordinary and customary meaning to a person of ordinary skill in the art and is not to be limited to a special or customized meaning. The term specifically may refer, without limitation, toa component that acts as an electron conductor. Thus, an electrode can cause an electric current to flow when an electric voltage is applied. Accordingly, an electrode is an electron conductor that interacts with a counter electrode (anode-cathode) with a medium located between the two electrodes. Electrodes consist of electrical conductors, usually a metal or graphite. They are used to connect non-electron-conducting areas with cables and are used for this purpose, for example, in electrochemical elements, as tools (e.g. in resistance spot welding) and, if necessary, material dispensers in electrofusion welding, as connections and electron-optical elements in electron tubes. Beyond the electrical function, electrode material can be deposited or consumed, or physical processes can take place in the electrode as in the anode of an Xray tube.

The term “temperature sensor” as used herein is a broad term and is to be given its ordinary and customary meaning to a person of ordinary skill in the art and is not to be limited to a special or customized meaning. The term specifically may refer, without limitation, toa component that provides an electrical signal as a measure of temperature. Such components may change their resistance as a function of temperature or directly produce a processable electrical signal. Components that change their resistance are thermistors (NTC), which reduce their resistance when the temperature increases. They are based on metal oxides or semiconductors and, when used for measurement purposes, are also called thermistors. Components that change their resistance are also PTC thermistors (PTC), which increase their resistance when the temperature is increased. For example, platinum measuring resistors have an almost temperature-linear resistance curve. Depending on the design, they can be used between −200° C. and +850° C. Silicon measuring resistors are used in the temperature range from −50° C. to +150° C. Ceramic PTC thermistors exhibit a sharp rise in resistance at a material-specific temperature. They can also be used as self-regulating heating elements or as thermal fuses.

Components that directly supply a processable electrical signal are integrated semiconductor temperature sensors (solid-state circuits) that supply a current proportional to their temperature, a voltage proportional to their temperature, or a digital signal dependent on their temperature. Other components that directly provide a processable electrical signal is a transistor. For example, the base-emitter voltage of a transistor connected as a diode decreases with increasing temperature.

In addition, other temperature sensors with contacting or non-contacting measuring methods can be used. In temperature sensors with oscillating quartz as measuring element, the resonant frequency of the oscillating quartz changes depending on the temperature and can be measured very precisely. Thermocouples convert a temperature difference into an electrical voltage through the Seebeck effect. Pyroelectric materials change the charge carrier density on their surface when the temperature varies by changing the spontaneous polarization. Used in pyrometers (mid-infrared radiation temperature measurement) and motion detectors. Pyrometers and thermal imaging cameras operate without contact and measure thermal radiation. Mechanically operating temperature switches, e.g., bimetal switches that operate a switch by curving a bimetal. Applications in toasters and irons. Ferromagnetic temperature sensors consist of a permanent magnet that adheres to ferromagnetic material below the Curie temperature and drops above that temperature, magnetically holding a spring-loaded mechanism or actuating reed switches. Depending on the distance between the magnet and the iron, the sensor automatically switches back on after cooling or must be reset. Patented application in temperature controlled soldering irons. Fiber optic temperature sensors measure the temperature profile along an optical fiber. They are based on the Raman effect or the temperature-dependent change of the refractive index in fiber Bragg grating sensors (FBGS).

The term “housing” as used herein is a broad term and is to be given its ordinary and customary meaning to a person of ordinary skill in the art and is not to be limited to a special or customized meaning. The term specifically may refer, without limitation, to a component adapted to at least partially surround the sample holder and electrodes. The housing may be formed in one piece or in multiple pieces. In any case, the housing is made of a material that is resistant to the temperatures prevailing during evaporation of the liquid. For example, the housing is a glass bell. The glass bell may be arranged on a base in the form of a pedestal. In this case, the base supports the sample holder and the electrodes. The housing has a port that allows removal of emissions produced during evaporation. For example, a tube or hose can be connected to the connection and the emissions can be extracted in order to feed them to an analysis device.

The term “ground joint” as used herein is a broad term and is to be given its ordinary and customary meaning to a person of ordinary skill in the art and is not to be limited to a special or customized meaning. The term specifically may refer, without limitation, to a compound of two glass devices used primarily in chemistry. A distinction is made between sleeves and cores on the devices, with a core always fitting into an associated sleeve. The sleeve is located, for example, on a glass bell or on the round-bottom flask, while the core is located on the corresponding further attachment devices such as reflux condenser or dropping funnel. The core devices also include the glass stoppers for closing currently unused openings. The connecting surface between the sleeve and the core is the ground joint; it is greased during use with a high-viscosity ground joint grease or sealed with ground joint sleeves made of PTFE or Teflon tape. A ground joint clamp is used to prevent the joint from coming apart. Differently sized ground joints can be connected with transition pieces.

In particular, the ground joint can be a standard ground joint, i.e. its dimensions are defined according to a standard. Standard ground joints in conical form are available according to DIN 12 242 in the sizes NS 5/13, 7/16, 10/19, 12/21, 14/23, 19/26, 24/29, 29/32, 34/35, 45/40, 60/46, 71/51 and 85/55; outside the standard, but based on it, 40/38, 50/42 and 55/44 are also available. The first number indicates the larger diameter in millimeters, the second the length. The pitch of the standard ground joint is always 1:20, which corresponds to a taper of 1:10. The taper with tolerance is given by ASTM E676-02 as 1±0.006 mm diameter: 10 mm length. There is also a measurement method for vacuum leakage measurement and diameter tolerances for taper ground joints. For ground joints, the sizes are NS 5/20, 7/25, 10/30, 12/32, 14/35, 19/38, 24/40, 29/42, 34/45, 40/50, 45/50, 50/50 and 55/50. They are mainly used for vacuum work because the sealing surfaces are larger. Core grindings are also available with constriction, extension, with a drip ring or with a drip tip, and in the case of dropping funnels also with wedge-shaped grindings to allow finer dosing. Double pieces (sleeve and core) for DIN 12 594 are available in the following sizes: core NS 14/23 and sleeve 14/23, core 19/26 and sleeve 19/26, core 29/32 and sleeve 14/23, and core 29/32 and sleeve 29/32. Spherical ground joints are available in the sizes specified in DIN 12244 Part 1. Where reference is made to standards in this application, this refers to the version valid on the filing date of this application.

The term “fleece” as used herein is a broad term and is to be given its ordinary and customary meaning to a person of ordinary skill in the art and is not to be limited to a special or customized meaning. The term specifically may refer, without limitation, to a structure of fibers of limited length, continuous fibers (filaments) or chopped yarns of any kind and of any origin, which have been joined together in any way to form a fleece (a layer of fibers, a pile of fibers) and bonded together in any way. Excluded from this is the interlacing or intertwining of yarns, as occurs in weaving, knitting, lace making, braiding and manufacture of tufted products. Fleece fabrics do not include foils and papers.

The indication “horizontal” refers to an orientation of a component in which the largest side surface of a surface is oriented perpendicular to the direction of gravity. The indication “substantially horizontal” refers to an orientation of a component that deviates no more than 15° and preferably no more than 5° from an exactly horizontal orientation.

The indication “vertical” refers to an orientation of a component in which the largest side surface of a surface is oriented parallel to the direction of gravity. The indication “substantially vertical” refers to an orientation of a component that deviates no more than 15° and preferably no more than 5° from an exactly vertical orientation.

The term “computer-implemented method” as used herein is a broad term and is to be given its ordinary and customary meaning to a person of ordinary skill in the art and is not to be limited to a special or customized meaning. The term specifically may refer, without limitation, to a process that operates under the action of a computer, computer network or other programmable device and in which at least one feature or process step is implemented in whole or in part with a computer program.

Further disclosed and proposed herein is a computer program including computer-executable instructions for performing the method according to the present invention in one or more of the embodiments enclosed herein when the instructions are executed on a computer or computer network. Specifically, the computer program may be stored on a computer-readable data carrier and/or on a computer-readable storage medium.

As used herein, the terms “computer-readable data carrier” and “computer-readable storage medium” specifically may refer to non-transitory data storage means, such as a hardware storage medium having stored thereon computer-executable instructions. The computer-readable data carrier or storage medium specifically may be or may comprise a storage medium such as a random-access memory (RAM) and/or a read-only memory (ROM).

Thus, specifically, one, more than one or even all of method steps a) to d) as indicated above may be performed by using a computer or a computer network, preferably by using a computer program.

Further disclosed and proposed herein is a computer program product having program code means, in order to perform the method according to the present invention in one or more of the embodiments enclosed herein when the program is executed on a computer or computer network. Specifically, the program code means may be stored on a computer-readable data carrier and/or on a computer-readable storage medium.

Further disclosed and proposed herein is a data carrier having a data structure stored thereon, which, after loading into a computer or computer network, such as into a working memory or main memory of the computer or computer network, may execute the method according to one or more of the embodiments disclosed herein.

Further disclosed and proposed herein is a non-transient computer-readable medium including instructions that, when executed by one or more processors, cause the one or more processors to perform . . . .

Further disclosed and proposed herein is a computer program product with program code means stored on a machine-readable carrier, in order to perform the method according to one or more of the embodiments disclosed herein, when the program is executed on a computer or computer network. As used herein, a computer program product refers to the program as a tradable product. The product may generally exist in an arbitrary format, such as in a paper format, or on a computer-readable data carrier and/or on a computer-readable storage medium. Specifically, the computer program product may be distributed over a data network.

Finally, disclosed and proposed herein is a modulated data signal which contains instructions readable by a computer system or computer network, for performing the method according to one or more of the embodiments disclosed herein.

Referring to the computer-implemented aspects of the invention, one or more of the method steps or even all of the method steps of the method according to one or more of the embodiments disclosed herein may be performed by using a computer or computer network. Thus, generally, any of the method steps including provision and/or manipulation of data may be performed by using a computer or computer network. Generally, these method steps may include any of the method steps, typically except for method steps requiring manual work, such as providing the samples and/or certain aspects of performing the actual measurements.

### Specifically, Further Disclosed Herein are:

a computer or computer network comprising at least one processor, wherein the processor is adapted to perform the method according to one of the embodiments described in this description,
a computer loadable data structure that is adapted to perform the method according to one of the embodiments described in this description while the data structure is being executed on a computer,
a computer program, wherein the computer program is adapted to perform the method according to one of the embodiments described in this description while the program is being executed on a computer,
a computer program comprising program means for performing the method according to one of the embodiments described in this description while the computer program is being executed on a computer or on a computer network,
a computer program comprising program means according to the preceding embodiment, wherein the program means are stored on a storage medium readable to a computer,
a storage medium, wherein a data structure is stored on the storage medium and wherein the data structure is adapted to perform the method according to one of the embodiments described in this description after having been loaded into a main and/or working storage of a computer or of a computer network, and
a computer program product having program code means, wherein the program code means can be stored or are stored on a storage medium, for performing the method according to one of the embodiments described in this description, if the program code means are executed on a computer or on a computer network.
   Summarizing and without Excluding Further Possible Embodiments, the Following Embodiments May be Envisaged:
Embodiment 1: A device for vaporizing a liquid for an electric cigarette, comprising
   a sample holder for holding a sample carrier, the sample carrier being at least partially made of an electrically conductive material, the sample carrier being configured to hold a predetermined amount of a liquid for an electric cigarette,
   two electrodes, the electrodes being configured to heat the sample carrier to at least a predetermined temperature by applying an electrical voltage to the sample carrier,
   a temperature sensor, wherein the temperature sensor is configured to detect a temperature of the sample carrier,
   a housing, the housing surrounding the sample holder and the electrodes, the housing having a port, the port being configured to remove emissions during heating of the predetermined amount of liquid.
Embodiment 2: The device according to the preceding embodiment, wherein the port is configured to connect to an analyzer port of an analyzer.
Embodiment 3: The device according to any of the preceding embodiments, wherein the housing is a glass bell, wherein the port is a sleeve of a ground joint.
Embodiment 4: The device according to the preceding embodiment, wherein the sleeve is configured to be connected to a core of a ground joint of a glass terminal.
Embodiment 5: The device according to any of the preceding embodiments, wherein the electrodes are integrated into the sample holder or are attachable to the sample carrier.
Embodiment 6: The device according to any of the preceding embodiments, further comprising a voltage source for applying the electrical voltage to the electrodes, wherein the electrical voltage is variable.
Embodiment 7: The device according to any of the preceding embodiments, wherein the electrodes are configured to heat the sample carrier with a predetermined temperature profile.
Embodiment 8: The device according to any of the preceding embodiments, wherein the sample carrier is at least partially and preferably completely porous.
Embodiment 9: The device according to any of the preceding embodiments, wherein the sample carrier is at least partially and preferably completely made of metal.
Embodiment 10: The device according to any of the preceding embodiments, wherein the sample carrier is a fleece.
Embodiment 11: The device according to any of the preceding embodiments, wherein the sample holder is configured for orienting the specimen carrier substantially vertically or substantially horizontally.
Embodiment 12: The device according to any of the preceding embodiments, wherein the temperature sensor contacts the sample carrier.
Embodiment 13: The device according to any one of embodiments 1 to 12, wherein the temperature sensor is configured for contactless detection of the temperature of the sample carrier.
Embodiment 14: The device according to the preceding embodiment, wherein the temperature sensor is arranged outside the housing.
Embodiment 15: The device according to any of the two preceding claims, wherein the temperature sensor is an infrared temperature sensor.
Embodiment 16: The device according to any of the preceding embodiments, further comprising a resistance measuring device, wherein the resistance measuring device is configured to measure an electrical resistance of the sample carrier.
Embodiment 17: The device according to any of the preceding embodiments, further comprising a base, wherein the housing is removably disposed on the base.
Embodiment 18: The device according to any one of the preceding embodiments, wherein the housing has a closable opening, the opening being sized to allow passage of a sample application device for applying the predetermined amount of liquid to the sample carrier.
Embodiment 19: A method for vaporizing a liquid for an electric cigarette comprising
   Applying a predetermined amount of liquid for an electric cigarette to a sample carrier, wherein the sample carrier is at least partially made of an electrically conductive material,
   Attaching the sample carrier to a sample holder,
   Arranging a housing such that the housing surrounds the sample holder and two electrodes, the housing having a connector,
   Heating the sample carrier to at least a predetermined temperature by applying an electrical voltage to the sample carrier by means of the two electrodes,
   Detecting a temperature of the sample carrier,
   Evaporating the predetermined amount of liquid at the predetermined temperature, and
   Removing of emissions during a heating of the predetermined amount of liquid.
Embodiment 20: The method according to the preceding embodiment, wherein the predetermined amount of liquid is applied before heating the sample carrier.
Embodiment 21: The method according to embodiment 19, wherein the predetermined amount of liquid is applied in a heated state of the sample carrier.
Embodiment 22: The method according to any one of embodiments 19 to 21, further comprising connecting the connector to a port of an analyzer.
Embodiment 23: The method according to any one of embodiments 19 to 22, further comprising varying the electrical voltage applied to the electrodes depending on the type of electric cigarette whose liquid is to be vaporized.
Embodiment 24: The method of any one of embodiments 19 to 23, further comprising heating the sample carrier with a predetermined temperature profile.
Embodiment 25: The method according to any one of embodiments 19 to 24, wherein the sample carrier is at least partially and preferably completely porous, wherein the predetermined amount of liquid is applied to the sample carrier such that the liquid at least partially penetrates the pores.
Embodiment 26: The method according to any one of embodiments 19 to 25, wherein the sample carrier is at least partially and preferably completely made of metal.
Embodiment 27: The method according to any one of embodiments 19 to 26, wherein the sample carrier is a fleece.
Embodiment 28: The method according to any one of embodiments 19 to 27, further comprising orienting the sample carrier substantially vertically or substantially horizontally.
Embodiment 29: The method of any one of embodiments 19 to 28, further comprising measuring an electrical resistance of the sample carrier.
Embodiment 30: The method of any one of embodiments 19 to 29, further comprising providing a base, wherein the housing is removably disposed on the base.
Embodiment 31: The method of any one of embodiments 19 to 30, further comprising exhausting emissions.
Embodiment 32: The method of any one of embodiments 19 to 31, further comprising analyzing the emissions using at least one analysis method in at least one analyzer.
Embodiment 33: The method according to any one of embodiments 19 to 32, wherein the method is performed using a device according to any one of embodiments 1 to 18.
Embodiment 34: The method according to any one of embodiments 19 to 33, wherein the method is computer-implemented.

### BRIEF DESCRIPTION OF THE FIGURES

Further optional features and embodiments will be disclosed in more detail in the subsequent description of embodiments, preferably in conjunction with the dependent claims. Therein, the respective optional features may be realized in an isolated fashion as well as in any arbitrary feasible combination, as the skilled person will realize. The scope of the invention is not restricted by the preferred embodiments. The embodiments are schematically depicted in the FIGURES. Therein, identical reference numbers in these FIGURES refer to identical or functionally comparable elements.

### In the FIGURE:

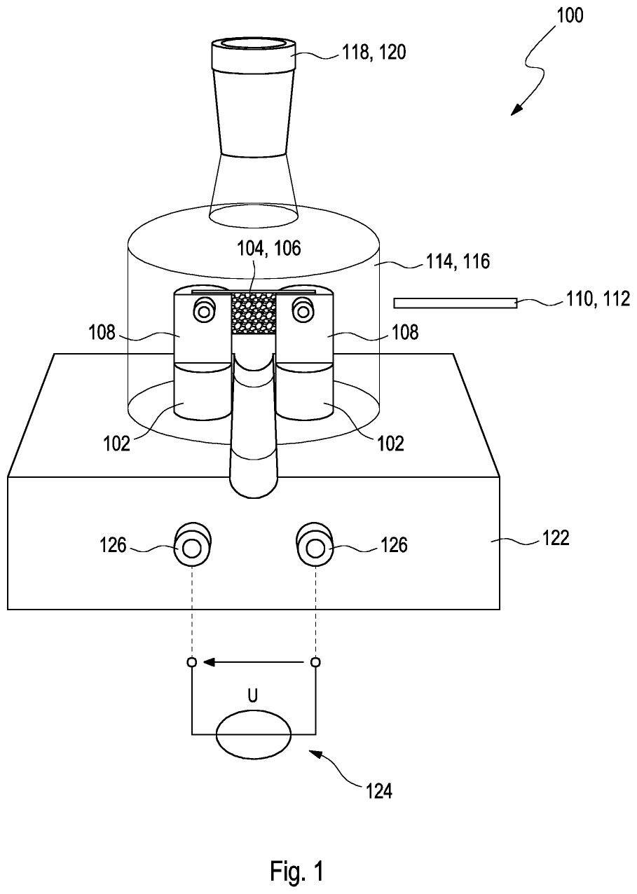

FIG. 1 shows a device for vaporizing a liquid for an electric cigarette according to an embodiment of the present invention.

### DETAILED DESCRIPTION OF THE EMBODIMENTS

FIG. 1 shows a device 100 for vaporizing a liquid for an electric cigarette according to an embodiment of the present invention. The device 100 includes a sample holder 102 for holding a sample carrier 104. The sample carrier 104 is at least partially made of an electrically conductive material. The sample carrier 104 is at least partially and preferably entirely made of metal, such as steel and in particular stainless steel. The sample carrier 104 is at least partially and preferably completely porous. In the embodiment shown, the sample carrier 104 is a fleece 106 and more specifically a metal fleece. The sample carrier 104 is configured to hold a predetermined amount of liquid for an electric cigarette. Accordingly, the sample carrier 104 is electrically conductive, temperature resistant, porous, and receives the liquid into its pores or cavities. The sample carrier 104 may have a comparatively small surface area of 1 cm² to 5 cm² and preferably 1 cm² to 2.5 cm², such as about 1.2 cm². In the embodiment shown, the sample support 104 is in the form of a strip, i.e., substantially in the form of a thin cuboid. In the embodiment shown, the sample holder 102 is configured to orient the sample carrier 104 substantially vertically. In this regard, the longest dimension and the shortest dimension of the cuboid shape extend perpendicular to the direction of gravity.

The device 100 further comprises two electrodes 108. The electrodes 108 are configured to heat the sample carrier 104 to at least a predetermined temperature by applying an electrical voltage to the sample carrier 104. In other words, the sample carrier 104 is heatable by means of applying an electrical voltage to the electrodes 108, as this creates a current flow through the sample carrier, which in turn causes heating. For this purpose, the electrodes 108 are electrically contactable with the sample carrier 104. In particular, the electrodes 108 are configured to heat the sample carrier 104 with a predetermined temperature profile. In the embodiment shown, the electrodes 108 are integrated into the sample holder 102. In other words, the sample holder 102 and the electrodes 108 are formed as a single unit. In particular, the electrodes 108 are formed as the sample holder 102.

The device 100 further comprises a temperature sensor 110. The temperature sensor 110 is configured to detect a temperature of the sample carrier 104. The temperature sensor 110 is configured to detect the temperature of the sample carrier 104 in a contactless manner. For example, the temperature sensor 110 is an infrared temperature sensor 112.

The device 100 further comprises a housing 114. The housing 114 surrounds the sample holder 102 and the electrodes 108. In the embodiment shown, the housing 114 is a glass bell 116. The housing 114 includes a port 118. The port 118 is configured for removing emissions during a heating of the predetermined amount of fluid. The port 118 is configured to connect to an analyzer port of an analyzer not shown in detail. In the embodiment shown, the port 118 is a sleeve 120 of a ground joint. The sleeve 120 is configured to connect to a core of a ground joint of a glass port of the analyzer. The temperature sensor 110 is disposed outside of the housing 114.

The device 100 further comprises a base 122. The housing 114 is removably disposed on the base 122. The sample holder 102 and the electrodes 108 are arranged or mounted on the base 122. The base 122 is made of a material that is inert or robust to the fluid and the products formed when heated, such as a ceramic material.

The device 100 further comprises a voltage source 124 for applying the electrical voltage to the electrodes 108. The electrical voltage is variable. In particular, the level of the applied electrical voltage can be adapted to an electric cigarette whose liquid is to be vaporized for sample preparation. The voltage source 124 can be connected to the electrodes 108, for example, by means of cables not shown in detail. Thus, terminals 126 of the electrodes 108 are arranged in or on the base 122 in the form of plug or cable sockets to which the cables can be connected.

The device 100 may be modified as follows. The electrodes 108 may be formed separately from the sample holder 102. For example, the electrodes 108 may be attachable to the sample holder 104 as electrical contacts or cables. In this case, the sample holder 102 is made of an electrically insulating material. The temperature sensor 110 may contact the sample carrier 104. For example, a sensor holder may be provided that is made of a temperature resistant and electrically insulating material and allows for the attachment of a temperature sensor 110 that contacts the sample carrier 104 and can thus provide real-time temperature data. Alternatively, or in addition to the temperature sensor 110, the device 100 may include a resistance measuring device configured to measure an electrical resistance of the sample carrier 104. The housing 114 may include a sealable or closable opening sized to allow passage of a sample application device for applying the predetermined amount of fluid to the sample carrier 104.

A method of vaporizing a liquid for an electric cigarette is described below. The method is described with reference to the device 100. Thus, the method represents one possible mode of operation of the device 100. The method may be computer implemented.

A predetermined amount of liquid for an electric cigarette is applied to a sample carrier 104. The predetermined amount of liquid is 1 μl to 500 μl and preferably 1.5 μl to 150 μl and more preferably 2 μl to 50 μl, such as 1 μl to 20 μl. The sample carrier 104 is attached to the sample holder 102. The sample carrier 104 is oriented substantially vertically. In this regard, the fluid may be applied to the sample carrier 104 prior to attaching the sample carrier 104 thereto. Alternatively, the sample carrier 104 is first attached to the sample holder 102 and then the liquid is applied to the sample carrier 104.

Then, the housing 114 is arranged such that the housing 114 surrounds the sample holder 102 and the electrodes 108. In particular, the housing 114 is disposed on the base 122. The port 118 is connected to a port of an analyzer.

Then, the voltage source 124 is connected to the electrodes 108. By means of applying an electrical voltage to the sample carrier 104 by means of the electrodes 108, the sample carrier 104 is heated to at least a predetermined temperature. The predetermined temperature is 200° C. to 600° C. and preferably 200° C. to 500° C., such as 300° C. The electrical voltage applied to the electrodes 108 is varied or adjusted depending on the type of electric cigarette whose liquid is to be vaporized. In particular, the sample carrier 104 is heated with a predetermined temperature profile. Accordingly, the predetermined amount of liquid is applied prior to heating the sample carrier 104. The predetermined amount of liquid is vaporized at the predetermined temperature. In the process, a temperature of the sample carrier 104 is sensed. The temperature sensor 110 may provide real-time temperature data. This can be used for temperature control and process monitoring.

As the liquid is heated and vaporized, the resulting emissions are removed from the housing 114. In particular, the emissions are extracted. Thus, the emissions produced during evaporation can be analyzed using at least one analytical method in at least one analytical instrument.

The method may be modified as follows. The sample carrier 104 may be oriented substantially horizontally in the sample holder 102. The predetermined amount of fluid may be applied in a heated state to the sample carrier 104. Alternatively, or in addition to temperature sensing by temperature sensor 110, an electrical resistance of sample carrier 104 may be measured.

The device 100 and method enable evaporation of a liquid sample at a defined temperature while minimizing local and temporal temperature differences. This is achieved by rapidly heating the sample to a set temperature. The sample carrier 104 is electrically conductive, temperature resistant, porous, and accepts the sample into its cavities. This heats the sample uniformly and prevents cooling of portions of the sample that are open to the air. External cooling effects are minimized as liquid is absorbed into the pores of the sample support 104 and thus evaporated from within. The open design of the device 100, unlike an electric cigarette, allows for meaningful real-time temperature control. The sample carrier 104 can be easily and inexpensively replaced after use, so that possible deposits do not affect the vaporization process. The device 100 also offers the ecological and economic advantage that wear parts, which are parts for a single use here, are limited to the sample carrier 104 and thus a simple component with a comparatively small surface area.

Through temperature control and temperature monitoring, the device 100 creates a standard that allows for generally applicable, non-hardware, i.e., electric cigarettes or vaporizer heads, dependent conclusions about the composition of the emissions of the liquids produced by heating. In the device 100 described herein, a very small amount of liquid, i.e., a few μL, is applied to a steel fleece 106, which immediately disperses by wetting. By applying a defined voltage, the fleece 106 is heated very quickly and the contained liquid is evaporated in the process. The temperature of the fleece 106 is adjusted by varying the applied voltage and precisely determined with the aid of the temperature sensor 110 used. The small amounts of liquid used have no effect on the temperature. By means of a pump, the generated aerosol can be extracted, deposited on suitable sorbents and then analyzed. Cooling effects are minimized by using a low volume flow. The fleece 106 can be inexpensively and easily replaced after use.

### LIST OF REFERENCE SIGNS

100 Device
102 Sample holder
104 Sample carrier
106 Fleece
108 Electrode
110 Temperature sensor
112 Infrared temperature sensor
114 Housing
116 Glass bell
118 Connection
120 Sleeve
122 Base
124 Voltage source
126 Connection of the electrode

1. A device for vaporizing a liquid for an electric cigarette, comprising
a sample holder for holding a sample carrier, the sample carrier being made at least in part of an electrically conductive material, the sample carrier being configured to hold a predetermined amount of liquid for an electric cigarette, two electrodes, the electrodes being configured to heat the sample carrier to at least one predetermined temperature by applying an electrical voltage to the sample carrier,
a temperature sensor, wherein the temperature sensor is configured to sense a temperature of the sample carrier,
a housing, the housing surrounding the sample holder and the electrodes, the housing having a port, the port being configured to remove emissions during heating of the predetermined amount of fluid.

2. The device according to claim 1, wherein the port is configured to connect to an analyzer port of an analyzer.

3. The device according to claim 1, wherein the housing is a glass bell, wherein the port is a sleeve of a ground joint.

4. The device according to claim 1, wherein the electrodes are integrated into the sample holder or are attachable to the sample carrier.

5. The device according to claim 1, further comprising a voltage source for applying the electrical voltage to the electrodes, wherein the electrical voltage is variable.

6. The device according to claim 1, wherein the electrodes are configured to heat the sample carrier with a predetermined temperature profile.

7. The device according to claim 1, wherein the sample carrier is at least partially porous.

8. The device according to claim 1, wherein the sample carrier is at least partially made of metal.

9. The device according to claim 1, wherein the sample carrier is a fleece.

10. The device according to claim 1, wherein the sample holder is configured to orient the sample carrier substantially vertically or substantially horizontally.

11. The device according to claim 1, wherein the temperature sensor contacts the sample carrier.

12. The device according to claim 1, wherein the temperature sensor is configured for contactless detection of the temperature of the sample carrier.

13. The device according to claim 12, wherein the temperature sensor is an infrared temperature sensor.

14. The device according to claim 1, further comprising a base, wherein the housing is removably disposed on the base.

15. The device according to claim 1, wherein the housing includes a sealable or closable opening, the opening being sized to allow passage of a sample application device for applying the predetermined amount of liquid to the sample carrier.

16. A method for vaporizing a liquid for an electric cigarette comprising
Applying a predetermined amount of liquid for an electric cigarette to a sample carrier, wherein the sample carrier is made at least in part of an electrically conductive material,
Attaching the sample carrier to a sample holder,
Arranging a housing such that the housing surrounds the sample holder and two electrodes, the housing having a connector,
Heating the sample carrier to at least one predetermined temperature by applying an electrical voltage to the sample carrier by means of the two electrodes,
Detecting a temperature of the sample carrier,
Evaporating the predetermined amount of liquid at the predetermined temperature, and
Removing of emissions during a heating of the predetermined amount of liquid.

17. The method according to claim 16, wherein the method is performed using a device according to claim 1.

18. The method according to claim 16, wherein the method is computer implemented.

19. The device according to claim 1, wherein the sample carrier is completely porous.

20. The device according to claim 1, wherein the sample carrier is completely made of metal.

21. The device according to claim 11, wherein the temperature sensor is an infrared temperature sensor.

22. The device according to claim 1, wherein the temperature sensor is arranged outside the housing.

23. The device according to claim 22, wherein the temperature sensor is an infrared temperature sensor.
